(19) United States
(12) Patent Application Publication
(10) Pub. No.: US 2009/0284380 A1
(43) Pub. Date: Nov. 19, 2009

(54) TEMPERATURE INDICATING DEVICE

(75) Inventors: KAI-YI CHEN, TAOYUAN CITY (TW); CHING-HUI CHEN, LINKOU TOWNSHIP (TW)

Correspondence Address: RABIN & Berdo, PC, 1101 14TH STREET, NW, SUITE 500, WASHINGTON, DC, 20005, US

(73) Assignees: SILITEK ELECTRONICS (GUANGZHOU) CO., LTD., Guangzhou (CN); LITE-ON TECHNOLOGY CORPORATION, Taipei City (TW)

(21) Appl. No.: 12/464,379

(22) Filed: May 12, 2009

(30) Foreign Application Priority Data
May 16, 2008 (CN) 200810028188.5

(51) Int. Cl. G08B 21/00

(52) U.S. Cl. 340/584

(57) ABSTRACT

A temperature indicating device includes a temperature sensing element, for sensing the temperature of an object and transforming the temperature into a signal; an illuminating unit, for emitting light of predetermined colors; a control unit, for receiving the signal from the temperature sensing element, and driving the illuminating unit to emit light of a predetermined color corresponding to the sensed temperature according to the signal; a power supply, for supplying power to the temperature sensing element, the control unit, and the illuminating unit; and a body, wherein the temperature sensing element, the illuminating unit, the control unit, and the power supply are located inside the body.

### BACKGROUND OF THE INVENTION

1. Field of the Invention

The invention generally relates to a temperature indicating device, especially to a temperature indicating device which emits light to indicate the temperature level of an object.

2. Description of Related Art

Among objects people inevitably touch in their daily life, some might be dangerous for them because of unnoticed temperature. The temperature of those objects cannot be recognized from their appearance, especially when the surrounding light is dim. Especially risky for elderly or young kids, but even the ordinary people might sometimes get burn when those hot objects are unintentionally touched. For example, a bather may be scalded when the bath water is hot and feel uncomfortable when the water is cold. However, the bather cannot tell how the bath water may feel simply from the color of water.

Usually, people get to know the temperature of an object from a temperature meter. This approach cannot work when the surrounding light is dim because it is difficult to read.

### SUMMARY OF THE INVENTION

It is an object of the present invention to provide a temperature indicating device, especially to a temperature indicating device which can emit light of predetermined colors to indicate corresponding temperature ranges.

In order to achieve the above and other objectives, the temperature indicating device of the present invention includes a temperature sensing element, for sensing the temperature of an object and transforming the temperature into a signal; an illuminating unit, for emitting light of predetermined colors; a control unit, for receiving the signal from the temperature sensing element, and driving the illuminating unit to emit light of a predetermined color corresponding to the sensed temperature according to the signal; a power supply, for supplying power to the temperature sensing element, the control unit, and the illuminating unit; and a body, wherein the temperature sensing element, the illuminating unit, the control unit, and the power supply are located inside the body.

The temperature indicating device of the present invention uses the control unit to receive the signal from the temperature sensing element, and accordingly drives the illuminating unit to emit light of the predetermined color corresponding to the temperature of an object to be measured. Different colors of the emitted light represent different temperature ranges so that the temperature ranges can be easily recognized in a straight forward way with less influence from the surrounding lights.

To provide a further understanding of the present invention, the following detailed description illustrates embodiments and examples of the present invention and is provided only for illustration of the present invention.

### BRIEF DESCRIPTION OF THE DRAWINGS

FIG. 1 is a block diagram of a temperature indicating device according to one embodiment of the present invention.

FIG. 2 is a schematic view of a temperature indicating device according to a first embodiment of the present invention.

FIG. 3 is a schematic view of a temperature indicating device according to a second embodiment of the present invention.

FIG. 4 is a schematic view of a temperature indicating device according to a third embodiment of the present invention.

FIG. 5 is a schematic view of a temperature indicating device according to a fourth embodiment of the present invention.

FIG. 6 is a schematic view of a temperature indicating device according to a fifth embodiment of the present invention.

### DETAILED DESCRIPTION OF THE PREFERRED EMBODIMENTS

Wherever possible in the following description, like reference numerals will refer to like elements and parts unless otherwise illustrated.

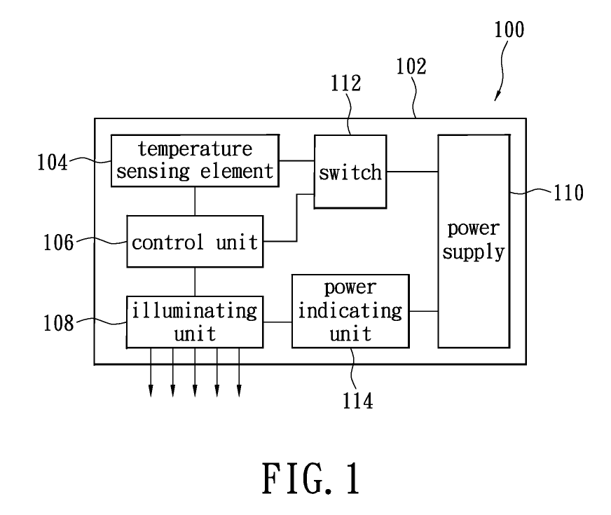

FIG. 1 is a block diagram of a temperature indicating device according to one embodiment of the present invention. The temperature indicating device 100 includes a body 102, a temperature sensing element 104, a control unit 106, an illuminating unit 108, a switch 112, a power indicating unit 114, and a power supply 110. The temperature sensing element 104, the control unit 106, the illuminating 108, the switch 112, the power indicating unit 114, and the power supply 110 are located inside the body 102.

The body 102 can be a casing of any shape such as ball shape, sheet shape, or in the form of a showerhead. The body 102 further has features of being waterproof and transparent. The temperature sensing element 104 inside the temperature indicating device 100 can be a thermal sensitive resistor and is electrically connected to the control unit 106. The temperature sensing element 104 senses the temperature of an object, and transforms the temperature into a signal, such as optoelectronic signal or electrical signal, and then outputs the signal to the control unit 106. The control unit 106 then drives, according to the received signal from the temperature sensing element 104, the illuminating unit 108 to emit light of a predetermined color corresponding to the sensed temperature.

In the temperature indicating device 100, the illuminating unit 108 can be one or more RGB light emitting diodes, and the illuminating unit 108 is electrically connected to the control unit 106. In one embodiment of the present invention, having the illuminating unit 108 emit blue light means the temperature is low, having the illuminating unit 108 emit green light means the temperature is moderate, and having the illuminating unit 108 emit red light means the temperature is too high. It is noted that the embodiment above is exemplified to illustrate the present invention, but not intended to limit the scope of the present invention. Other colors can be used to indicate the level of sensed temperature.

The control unit 106 is used to receive the signal from the temperature sensing element 104 and accordingly drives the illuminating unit 108 to emit lights of different colors according to the corresponding temperature ranges. By means of settings of the control unit 106, the illuminating unit 108 can show different expression of emitted lights, such as a flickering ambient light or gradation light.

The power supply 110 is used to supply power to the temperature sensing element 104, the control unit 106, and the illuminating unit 108. In this embodiment, the power supply 110 can be a rechargeable battery or an ordinary battery.

The switch 112 is used to respectively connect or disconnect the power supply 110 to or from the temperature sensing element 104, the control unit 106, and the illuminating unit 108. The power indicating unit 114 is used to indicate the power status of the power supply 110. By emitting light of corresponding colors, it is easy to tell whether the power supply 110 turns on, turns off, or is charging. For example, emitting blue light means the power turns on, emitting red light means no power, emitting yellow light means charging, and emitting green light means fully charged.

In the case that the power supply 110 of the temperature indicating device 100 uses rechargeable battery. A charger of the rechargeable battery can be a contactless battery charger, such as an electromagnetically induced charger, which can perform charging without contacting the battery. Since the implementation of the rechargeable battery is well known to those skilled in the art, the description of and accompanied drawings details thereof is omitted.

The control unit 106 of the temperature indicating device 100 according to the present invention drives the illuminating unit 108 to emit light after receiving the signal from the temperature sensing element 104. Different colors of the emitted light represent different temperature ranges so that the temperature ranges can be easily recognized in a straight forward way with less influence from the surrounding lights. By means of settings of the control unit 106, the illuminating unit 108 can show different expression of emitted lights, such as a flickering ambient light or gradation light, so that the temperature indicating device 100 can be widely applied. Furthermore, the power supply 110 uses the rechargeable battery or the ordinary battery rather than a fixed power line, which renders the temperature indicating device 100 more convenient to carry without being limited in the area of application sites.

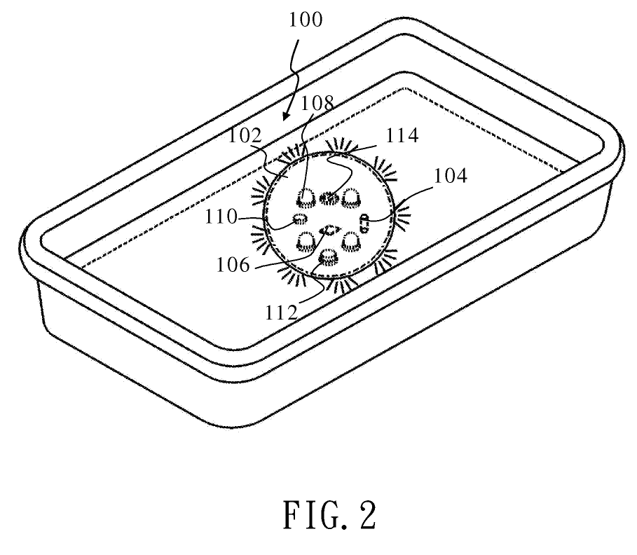

FIG. 2 is a schematic view of a temperature indicating device according to a first embodiment of the present invention. The body 102 of the temperature indicating device 100 is a closed, transparent, and ball-shaped casing. It is noted that the embodiment above is exemplified to illustrate the present invention, but not intended to limit the scope of the present invention. Other shaped casing can be used to be the body of the temperature indicating device. The temperature sensing element 104, the control unit 106, the illuminating unit 108, the switch 112, the power indicating unit 114, and the power supply 110 are located inside the body 102. The body 102 can be waterproof and transparent. In this embodiment, the temperature indicating device 100 can be placed in a not completely enclosed container so as to test the temperature of liquid in the container such as a cup or a bathtub. In this case, the body 102 can be a kid toy or a water stopper.

In this embodiment, the body 102 is a water stopper for the bathtub. The body 102 can be made of flexible, waterproof, and transparent material such as silicon. When the body 102 is placed into the bathtub to test the temperature of water, the power supply 110 of the temperature indicating device 100 can be controlled to turn on or off by pushing down the part of the body 102 aligning to the switch 112.

By means of settings of the control unit 106, when the temperature of water in the bathtub is in the range of 0° C.˜36° C., the illuminating unit 108 emits blue light which means the water temperature is lower. When the temperature of water in the bathtub is in the range of 36° C.˜40° C., the illuminating unit 108 emits green light which means the water temperature is moderate. When the temperature of water in the bathtub is higher than 40° C., the illuminating unit 108 emits red light which means the water temperature is too high to bath. Such ways to represent the color match the common senses to the corresponding colors for ordinary people (i.e. blue and red on infrared scale means cold and hot, and green tends to mean safe to go such as a green traffic light), so that people need not to memorize counter-intuitive color schemes when they use the temperature indicating device of the present invention. Furthermore, since the body 102 sits on a water exit of the bathtub, it helps stop water draining out and can sense the water temperature as soon as the water enters into the bathtub.

In order to meet the requirements of waterproof characteristic and convenience for carrying, the power supply 110 uses the rechargeable battery. The rechargeable battery is sealed inside the body 102. When it needs recharging, an electromagnetically induced charger can be used because no outer charging port is used. It is noted that the above temperature range is exemplified for illustration, and is not intended to limit the scope of the present invention. The temperature range can be changed by setting the control unit 106 according to actual need.

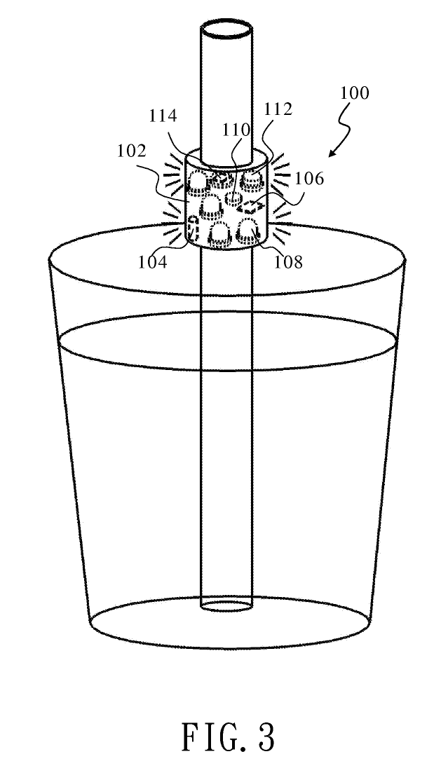

FIG. 3 is a schematic view of a temperature indicating device according to a second embodiment of the present invention. The body 102 of the temperature indicating device 100 in this embodiment can be a sheet-shaped casing such as an attachable sheet. The body 102 can be made of a flexible, waterproof, and transparent material such as silicon. The temperature sensing element 104, the control unit 106, the illuminating unit 108, the switch 112, the power indicating unit 114, and the power supply 110 are located inside the body 102. One side of the body 102 has an adhesive layer or a sucking disk so that the temperature indicating device 100 can be adhered or sucked (i.e. attached) to an object such as a water pipe, stopcock, a straw, or a container wall.

As soon as liquid flows through a water pipe, a stopcock, a straw, or a container wall, the temperature indicating device 100 senses the temperature of the liquid. In this embodiment, the temperature indicating device 100 adheres to the straw. The power supply 110 of the temperature indicating device 100 can be controlled to turn on or off by pushing down the part of the body 102 aligning to the switch 112. The temperature indicating device 100 can detect the temperature of the liquid by using the temperature sensing element 104 to sense the temperature of the liquid flowing through the straw.

By means of settings of the control unit 106, when the temperature of the liquid is in the range of 0° C.˜10° C., the illuminating unit 108 emits blue light which means the liquid to be drunk is cold. When the temperature of the liquid is in the range of 10˜40° C., the illuminating unit 108 emits green light which means the liquid to be drunk is warm. When the temperature of the liquid is higher than 40° C., the illuminating unit 108 emits red light which means the liquid to be drunk is hot and warns the drinker it might cause scalding.

In order to meet the requirements of waterproof characteristic and convenience for carrying, the power supply 110 uses the rechargeable battery. The rechargeable battery is sealed inside the body 102. When it needs recharging, an electromagnetically induced charger can be used because no outer charging port is used. It is noted that the above temperature range is exemplified for illustration, not intended to limit the scope of the present invention. The temperature range can be changed by setting the control unit 106 according to actual need.

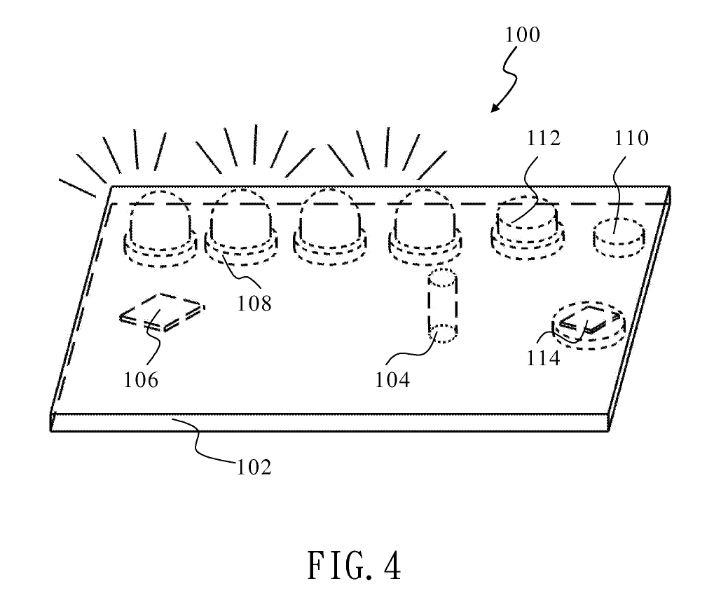

FIG. 4 is a schematic view of a temperature indicating device according to a third embodiment of the present invention. The temperature indicating device 100 includes a body 102. The body 102 in this embodiment is a sheet-shaped casing such as an attachable sheet but implemented in different way from the second embodiment. The body 102 can be a body temperature card. The body 102 can be made of a flexible, waterproof, and transparent material such as silicon. The temperature sensing element 104, the control unit 106, the illuminating unit 108, the switch 112, the power indicating unit 114, and the power supply 110 are located inside the body 102. In order to meet the requirements of waterproof characteristic and convenience for carrying, the power supply 110 uses the rechargeable battery. The rechargeable battery is sealed inside the body 102. When it needs charging, an electromagnetically induced charger can be used because no outer charging port is used. When the body temperature card is placed on to an object for detecting the temperature of the object, such as the skin surface of a human body, the power supply 110 of the temperature indicating device 100 can be controlled to turn on or off by pushing down the part of the body 102 aligning to the switch 112.

By means of settings of the control unit 106, when the temperature of the user is lower than 36° C., the illuminating unit 108 emits blue light which means the temperature of the user is low. When the temperature of the user is in the range of 36˜37.5° C., the illuminating unit 108 emits green light which means the temperature of the user is normal. When the temperature of the user is in the range of 37.5° C.˜38° C., the illuminating unit 108 emits red light which means the temperature of the user is abnormal and the user might be feverish. When the temperature of the skin coming into contact is higher than 38° C., and the illuminating unit 108 flashes red light to warn the user of such a dangerous situation. Since the temperature of the human body subtly changes as the locations of the skin surfaces, the normal range of the body temperature card can be altered according to the actual needs.

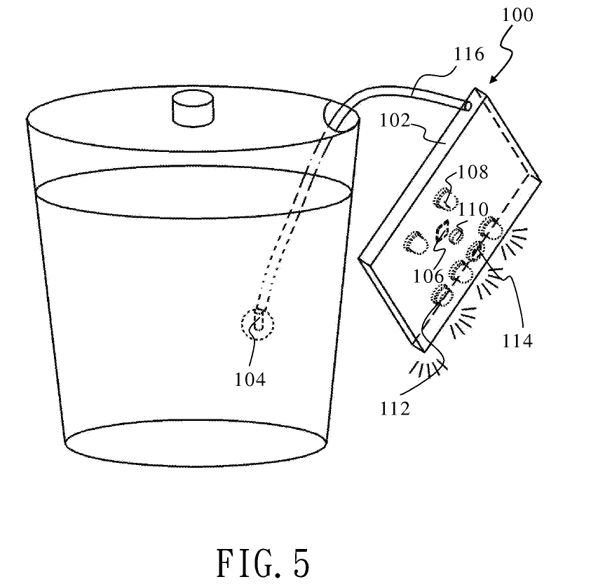

FIG. 5 is a schematic view of a temperature indicating device according to a fourth embodiment of the present invention. The body 102 of the temperature indicating device 100 in this embodiment is a tea bag-shaped casing. The temperature indicating device 100 further includes a connecting line 116 extending out from the body 102 so as to connect the temperature sensing element 104 to the body 102. In other words, the temperature sensing element 104 and the body 102 are respectively located at opposite ends of the connecting line 116. The control unit 106, the illuminating unit 108, the switch 112, the power indicating unit 114, and the power supply 110 are located inside the body 102.

The temperature sensing element 104 electrically connects to the control unit 106 of the body 102 through the connecting line 116. The control unit 106 drives the illuminating unit 108 to emit light pass through the transparent body 102 after receiving a signal from the temperature sensing element 104. Different colors of the emitted light represent different temperature ranges so that the temperature ranges can be easily recognized in a straight forward manner with less influence from surrounding light environments.

The temperature indicating device 100 can be applied to an opaque container with a lid. One end of the connecting line 116 having the temperature sensing element 104 is placed into a liquid, such as beverage, hot tea or coffee, to measure the temperature of the liquid, while the body 102 at the other end of the connecting line 116 is placed outside the container. The power supply 110 of the temperature indicating device 100 can be controlled to turn on or off by pushing down the part of the body 102 aligning with the switch 112. The temperature of the liquid sensed by the temperature sensing element 104 is transmitted to the control unit 106 through the connecting line 116.

By means of settings of the control unit 106, when the temperature of the liquid is in the range of 0° C.˜10° C., the illuminating unit 108 emits blue light which means the liquid is cold. When the temperature of the liquid is in the range of 10° C.˜40° C., the illuminating unit 108 emits green light which means the liquid is warm. When the temperature of the liquid is higher than 40° C., the illuminating unit 108 emits red light which means the liquid is hot and might cause scalding. Therefore, it is easy to indicate and notify the temperature of the liquid inside an opaque container.

In order to meet the requirements of waterproof characteristic and convenience for carrying, the tea bag-shaped power supply 110 uses the rechargeable battery. The rechargeable battery is sealed inside the body 102. When it needs charging, an electromagnetically induced charger can be used because no outer charging port is used. It is noted that the above temperature range is exemplified for illustration, not intended to limit the scope of the present invention. The temperature range can be changed by setting the control unit 106 according to actual needs.

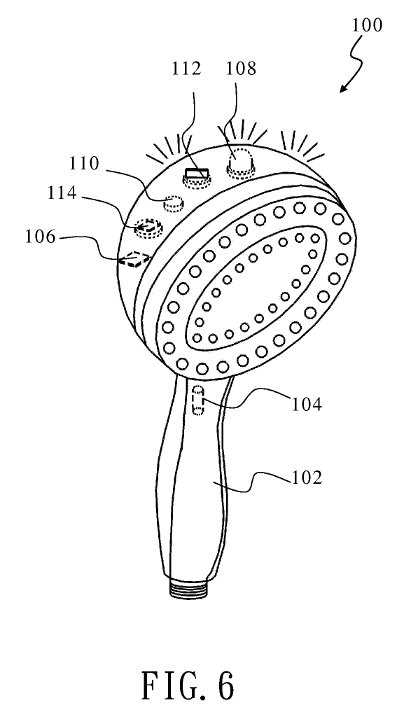

FIG. 6 is a schematic view of a temperature indicating device according to a fifth embodiment of the present invention. The body 102 of the temperature indicating device 100 in this embodiment is a showerhead casing. The temperature sensing element 104, the control unit 106, the illuminating unit 108, the switch 112, the power indicating unit 114, and the power supply 110 are located inside the body 102. The temperature sensing element 104 is arranged on an inner pipe wall of an entrance of the body 102. The temperature of water can be detected as soon as water flows through the inner pipe wall of the entrance of the body 102. The temperature sensing element 104 is further electrically connected to the control unit 106 of the body 102 so that the control unit 106 can drive the illuminating unit 108 to emit light after receiving a signal from the temperature sensing element 104. Different colors of the emitted light represent different temperature ranges. The body 102 can be waterproof and transparent so that the temperature ranges can be easily recognized in a straight forward way with less influence from surrounding lights.

In order to meet the requirements of waterproof characteristic and convenience for carrying, the power supply 110 uses the rechargeable battery. The rechargeable battery is sealed inside the body 102. When it needs charging, an electromagnetically induced charger can be used because no outer charging port is used. Furthermore, the switch 112 can be a switching mechanism that exposes from the body 102 and is therefore convenient for the user to turn on the power supply 110. A waterproof cover can be added to the switch 112 so as to prevent water from getting into the temperature indicating device 100.

By means of settings of the control unit 106, when the temperature of water is in the range of 0° C.˜36° C., the illuminating unit 108 emits blue light which means the shower water is cold. When the temperature of water is in the range of 36° C.˜40° C., the illuminating unit 108 emits green light which means the shower water is warm. When the temperature of water is higher than 40° C., the illuminating unit 108 emits red light which means the shower water is hot and it might be dangerous to take shower with such a high water temperature. It is noted that the temperature range above is exemplified to illustrate the present invention, but not intended to limit the scope of the present invention. Any temperature range can be set to the control unit 106 according actual needs.

In light of above, the temperature indicating device 100 of the present invention uses the control unit 106 to receive the signal from the temperature sensing element 104, and accordingly drives the illuminating unit 108 to emit light of the predetermined color corresponding to the temperature of an object to be tested. Different colors of the emitted light represent different temperature ranges so that the temperature ranges can be easily recognized in a straight forward way with less influence from the surrounding lights. Therefore, the temperature indicating device can work even in the dark.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A temperature indicating device, comprising:
a temperature sensing element, for sensing the temperature of an object and transforming the temperature into a signal;
an illuminating unit, for emitting light of predetermined colors;
a control unit, electrically connected to the temperature sensing element and the illuminating unit, for receiving the signal from the temperature sensing element, and driving the illuminating unit to emit light of the predetermined color corresponding to the sensed temperature according to the signal;
a power supply, for supplying power to the temperature sensing element, the control unit, and the illuminating unit; and
a ball-shaped casing, wherein the temperature sensing element, the illuminating unit, the control unit, and the power supply are located inside the ball-shaped casing.

2. The temperature indicating device of claim 1, wherein the ball-shaped casing is a water stopper.

3. The temperature indicating device of claim 1, wherein the ball-shaped casing is a transparent and waterproof casing.

4. The temperature indicating device of claim 1, wherein the power supply is a rechargeable battery or an ordinary battery.

5. The temperature indicating device of claim 1, wherein the temperature indicating device further comprises a switch and a power indicating unit, wherein the switch is used to connect or disconnect the power supply to and from the temperature sensing element, the control unit, and the illuminating unit, and the power indicating unit is used to indicate the power status of the power supply.

6. The temperature indicating device of claim 1, wherein the illuminating unit is one or more RGB light emitting diodes.

7. A temperature indicating device, comprising:
a temperature sensing element, for sensing the temperature of an object and transforming the temperature into a signal;
an illuminating unit, for emitting light of predetermined colors;
a control unit, electrically connected to the temperature sensing element and the illuminating unit, for receiving the signal from the temperature sensing element, and driving the illuminating unit to emit light of the predetermined color corresponding to the sensed temperature according to the signal;
a power supply, for supplying power to the temperature sensing element, the control unit, and the illuminating unit; and
a sheet-shaped casing, wherein the illuminating unit, the control unit, and the power supply are located inside the sheet-shaped casing.

8. The temperature indicating device of claim 7, wherein the sheet-shaped casing is an attachable sheet, and the temperature sensing element is located inside the sheet-shaped casing.

9. The temperature indicating device of claim 8, wherein the sheet-shaped casing is a body temperature card, and the temperature sensing element is located inside the sheet-shaped casing.

10. The temperature indicating device of claim 7, wherein the sheet-shaped casing is tea bag-shaped casing.

11. The temperature indicating device of claim 10, wherein further comprises:
a connecting line connecting the temperature sensing element to the control unit of the sheet-shaped casing, wherein the temperature sensing element and the sheet-shaped casing are respectively located at opposite ends of the connecting line.

12. The temperature indicating device of claim 7, wherein the sheet-shaped casing is a transparent and waterproof casing.

13. The temperature indicating device of claim 7, wherein the power supply is a rechargeable battery or an ordinary battery.

14. The temperature indicating device of claim 7, wherein the temperature indicating device further comprises a switch and a power indicating unit, wherein the switch is used to connect or disconnect the power supply to and from the temperature sensing element, the control unit, and the illuminating unit, and the power indicating unit is used to indicate the power status of the power supply.

15. The temperature indicating device of claim 7, wherein the illuminating unit is one or more RGB light emitting diodes.

16. A temperature indicating device, comprising:
a temperature sensing element, for sensing the temperature of an object and transforming the temperature into a signal;
an illuminating unit, for emitting light of predetermined colors;
a control unit, for receiving the signal from the temperature sensing element, and driving the illuminating unit to emit light of the predetermined color corresponding to the sensed temperature according to the signal;
a power supply, for supplying power to the temperature sensing element, the control unit, and the illuminating unit; and
a showerhead casing, wherein the temperature sensing element, the illuminating unit, the control unit, and the power supply are located inside the showerhead casing.

17. The temperature indicating device of claim 16, wherein the showerhead casing is a transparent and waterproof casing.

18. The temperature indicating device of claim 16, wherein the power supply is a rechargeable battery or an ordinary battery.

19. The temperature indicating device of claim 16, wherein the temperature indicating device further comprises a switch and a power indicating unit, wherein the switch is used to connect or disconnect the power supply to and from the temperature sensing element, the control unit, and the illuminating unit, and the power indicating unit is used to indicate the power status of the power supply.

20. The temperature indicating device of claim 16, wherein the illuminating unit is one or more RGB light emitting diodes.
